(19) United States
(12) Patent Application Publication
(10) Pub. No.: US 2024/0004023 A1
(43) Pub. Date: Jan. 4, 2024

(54) Mapping Electromagnetic Signatures in an Environment

(71) Applicant: GM Cruise Holdings LLC, San Francisco, CA (US)

(72) Inventor: Burkay Donderici, Burlingame, CA (US)

(73) Assignee: GM Cruise Holdings LLC, San Francisco, CA (US)

(21) Appl. No.: 17/854,185

(22) Filed: Jun. 30, 2022

(51) Int. Cl. G01S 5/02

(52) U.S. Cl. CPC G01S 5/02524; G01S 5/02522; G01S 5/02527

(57) ABSTRACT

An autonomous vehicle (AV) has an electromagnetic (EM) sensor that captures EM sensor data about the environment. The captured EM data is processed to generate an EM map of the environment. The EM data may also be used to identify EM characteristics of the environment. The EM map may be used to modify control and operation of the AV and may also be used to signal conditions to another system managing AVs, to correct localization of the AV, identify anomalies in the environment, and modify a previous signature EM map.

### BACKGROUND

This disclosure relates generally to environment mapping and more particularly to mapping an environment with electromagnetic (EM) sensor data.

Autonomous vehicles (AVs) navigate in environments by sensing the environment with various types of sensors to determine the current state of the environment. In general, AVs identify information in the environment with sensors such as image sensors (e.g., cameras), and may also use LIDAR or RADAR sensors to measure distances to objects. Despite advances in accuracy of these sensors and in perception algorithms, additional details remain that may be determined from the environment to be effectively represented and mapped by the AV to improve accuracy of the perceived environment relative to actual physical conditions of the environment.

### BRIEF DESCRIPTION OF THE DRAWINGS

FIG. 1 shows example components of an autonomous vehicle, according to one embodiment.

FIG. 2 shows components of the control system 130, according to one embodiment.

FIGS. 3-5 show example environments in which an AV may sense EM signals and use the received signals to characterize the environment, according to various embodiments.

FIG. 6 provides a flow for processing EM sensor data to generate an EM map, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

To increase perception of the environment, an AV includes an electromagnetic (EM) sensor that captures EM sensor data used to characterize the environment of the AV with respect to EM signals and generate an EM map based on the signals. As various types of objects and conditions emit different EM radiation, the received sensor data may be used to characterize the environment based on what EM sensor data is received at different locations in the environment and may also describe respective objects and other conditions. The AV may also localize itself with respect to a location in the environment (e.g., via GPS or other sensor data) and describe the EM data and/or determined environmental characteristics with respect to the environment to generate an EM map of the location.

The mapped EM data (e.g., the EM map) may then be used for various purposes. In one embodiment, the EM map is used (optionally in addition to other data) to modify the operation of the AV as the AV navigates the environment. For example, the EM map may be used to identify or confirm the location of objects in the environment that the AV may account for in further navigation of the environment. Or, an environmental condition may be detected, such as weather conditions or abnormally high EM signals that may indicate conditions of the environment that may be accounted for in operating the AV. For example, abnormally high EM signals may be used to set the AV to a “high alert” mode with more cautious operational parameters.

In another example, the EM map may also be compared with a prior EM map of the location and used to identify an anomaly in the currently-determined EM map and the previous map of the same location. This may be used, for example, to update the previous map with new EM signals or objects detected in the environment based on the EM sensor data. As another example, the previous EM map may describe EM sensor data as they may vary over time or probabilistically, such that an anomaly may be determined with respect to the “normal” behavior at that location. These anomalies may also be used to describe characteristics or attributes of the environment, for example, the EM signatures of a busy factory or the number and location of vehicles in the road may affect the received EM sensor data. When the EM map is different or unexpected from the previous map, it may reflect conditions that may be communicated to an external system for controlling the navigation of other autonomous vehicles, e.g., to avoid an unusually busy area. As another example, the EM map may also differ from the previous map when the determined localization for the AV is erroneous. The EM sensor data and/or identified EM signatures may then be used to update the location of the AV and identify other possible locations in the previous map that may be more consistent with detected EM sensor data. As such, detection of EM sensor data and incorporation of EM sensor data into mapping and perception of the AV may improve accurate representation of the environment and improve operation of the AV with respect to the physical environment.

Additional details and variations of these aspects are further discussed in detail below.

As will be appreciated by one skilled in the art, aspects of the present disclosure, may be embodied in various manners (e.g., as a method, a system, a computer program product, or a computer-readable storage medium). Accordingly, aspects of the present disclosure may be implemented in hardware, software, or a combination of the two. Thus, processes may be performed with instructions executed on a processor, or various forms of firmware, software, specialized circuitry, and so forth. Such processing functions having these various implementations may generally be referred to herein as a “module.” Functions described in this disclosure may be implemented as an algorithm executed by one or more hardware processing units, e.g., one or more microprocessors of one or more computers. In various embodiments, different steps and portions of the steps of each of the methods described herein may be performed by different processing units and in a different order, unless such an order is otherwise indicated, inherent, or required by the process. Furthermore, aspects of the present disclosure may take the form of one or more computer-readable medium(s), e.g., non-transitory data storage devices or media, having computer-readable program code configured for use by one or more processors or processing elements to perform related processes. Such a computer-readable medium(s) may be included in a computer program product. In various embodiments, such a computer program may, for example, be sent to and received by devices and systems for storage or execution.

This disclosure presents various specific examples. However, various additional configurations will be apparent from the broader principles discussed herein. Accordingly, support for any claims which issue on this application is provided by particular examples, as well as such general principles, as will be understood by one having ordinary skill in the art.

In the following description, reference is made to the drawings where like reference numerals can indicate identical or functionally similar elements. Elements illustrated in the drawings are not necessarily drawn to scale. Moreover, certain embodiments can include more elements than illustrated in a drawing or a subset of the elements illustrated in a drawing. Further, some embodiments can incorporate any suitable combination of features from two or more drawings.

As described herein, one aspect of the present technology may be the gathering and use of data available from various sources to improve quality and experience. The present disclosure contemplates that in some instances, this gathered data may include personal information. The present disclosure contemplates that the entities involved with such personal information respect and value privacy policies and practices.

The following disclosure describes various illustrative embodiments and examples for implementing the features and functionality of the present disclosure. While particular components, arrangements, or features are described below in connection with various examples, these are merely examples used to simplify the present disclosure and are not intended to be limiting.

Reference may be made to the spatial relationships between various components and to the spatial orientation of various aspects of components as depicted in the attached drawings. However, the devices, components, members, apparatuses, etc. described herein may be positioned in any desired orientation. Thus, the use of terms such as “above,” “below,” “upper,” “lower,” “top,” “bottom,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having,” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” generally refers to an inclusive use of “or” (including combinations of listed elements) rather than an exclusive use of “or” (exclusive selection of one element) unless expressly indicated or otherwise inherent to the use of “or.”

### System Overview

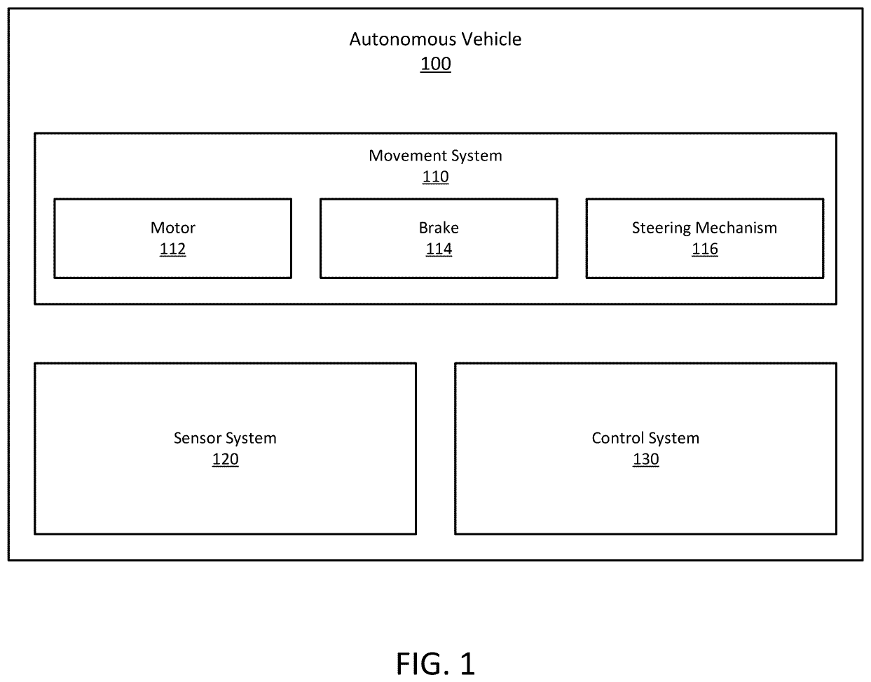

FIG. 1 shows example components of an autonomous vehicle 100, according to one embodiment. In general, an autonomous vehicle 100 includes a movement system 110 to affect physical movement of the autonomous vehicle 100 within an environment surrounding the vehicle, a sensor system 120 that includes a set of sensors for capturing information about the movement of the autonomous vehicle 100 and receiving information about the environment, and a control system 130 that perceives the environment and provides control to the movement system 110 for moving the autonomous vehicle 100 within the environment. In various embodiments, the autonomous vehicle 100 may be completely autonomous and the movement system 110 may be controlled without manual user operation, and in other embodiments may be partially autonomous, such that certain functions or features are automatically provided by the control system 130. In other instances, a user may manually control operation of the movement system 110, for example through various types of manual control mechanisms or inputs, such as pedals, steering wheel, gearbox control, etc. Such manual operation may be provided by an occupant of the autonomous vehicle 100 or may be provided remotely via a communication link to an external operator. In some embodiments, the autonomous vehicle 100 may transition operation to modes with more or less autonomous control based on various conditions, such as a user request, vehicle conditions, or environmental conditions. The autonomous vehicle 100 may also operate with or without an occupant in various embodiments or may activate or deactivate autonomous functions based on occupancy. In some embodiments the autonomous vehicle 100 may include no passenger cabin.

The movement system 110 includes various components for affecting movement of the autonomous vehicle 100 in the environment. As such, the movement system 110 may include a motor 112 that may be connected to a drive system (e.g., wheels) that moves the autonomous vehicle 100. The motor 112 may have multiple operation modes for moving forward, backward, or set to neutral, and may also be set to different speeds/torques (e.g., via various gear ratios). The motor 112 may also be capable of different levels of power output as controlled by a throttle. The movement system 110 may also include a brake 114 for slowing or stopping the movement of the autonomous vehicle 100 along with a steering mechanism 116 for changing the direction of travel of the autonomous vehicle 100. In general, the particular implementation of the components of the movement system 110 enable the autonomous vehicle to start, stop, and change direction in its environment, and may vary according to the particular type of the autonomous vehicle 100. Generally, the movement system 110 thus represents the mechanical components for movement and are controlled by signals received from the control system 130 that designate, for example, an amount of output by the motor, a steering direction for the steering mechanism 116, and so forth.

The sensor system 120 includes a set of sensors for monitoring the autonomous vehicle 100 and the environment around the autonomous vehicle 100. The particular set of sensors and the arrangement thereof may vary according to different examples. As examples, the sensors may include various sensors for monitoring the mechanical performance of the autonomous vehicle 100, such as sensors for monitoring motor performance, fluid levels, air pressure, wheel rotation speed, etc.

The sensors may also include various sensors for localization of the autonomous vehicle 100 within the environment and for perceiving the environment of the autonomous vehicle 100. In general, these sensors may capture various types of modalities of information, such as audio, video, and various electromagnetic frequencies. The sensors may include passive (e.g., receipt-only) and active sensing technologies (e.g., environmental scanning with active transmission and receipt of a return signal). Although certain sensors are discussed here, in practice, more or fewer sensors may be included according to the particular configuration of the various embodiments. The sensors may include one or more imaging sensors, which may include visible-light imaging sensors (e.g., a camera) or an infrared (IR) imaging sensor, radio detection and ranging (RADAR) sensors, or light detection and ranging (LIDAR) sensors. The sensors may also include a receiver for global positioning satellite (GPS) location data, a compass, and receivers for wireless signals, such as cellular or other wireless networks. The sensors may also include receivers for various electromagnetic (EM) signals in various frequencies along with microphones for receipt of audio and other sound information from the environment.

The AV may capture EM signals (i.e., EM sensor data) with various types of EM sensors. Such sensors typically operate as an antenna for receiving and interpreting electrical and/or magnetic fields along one or more dimensions, and together are referred to as EM signals. Such EM signals may thus include different types of radiated or emitted waves in different portions of the electromagnetic spectrum in various frequencies depending on the particular embodiment and may include non-visible waves, such as radio or microwaves. In additional embodiments, the EM sensors may be capable of capturing EM higher frequencies than visible light, such as ultra-violet, x-rays, or gamma rays. The specific implementation of the EM sensor may vary in different embodiments, and may include, for example, a dipole antenna, a parabolic antenna, a resonant antenna, an ultra-wide-band antenna, and/or signals received and measurable by a chassis of the AV.

Each sensor may also capture information in respective data formats and modalities according to the capacities of the sensors. For example, an imaging sensor typically captures received light as a two-dimensional image having one or more channels. As such, a visible light camera typically describes color images with color channels in an image space (e.g., as values of red-green-blue, hue-saturation-lightness, hue-saturation-value, cyan-yellow-magenta-key, etc.), while an infrared camera may describe received infrared frequencies in one channel. Similarly, audio capture with a microphone may be described as a frequency waveform, while RADAR/LIDAR data may be represented as a point cloud of data points representing the environment as points at varying distances from the sensor.

The position and placement of the sensors may also vary according to different embodiments and may be calibrated with respect to characteristics of each individual sensor and also with respect to one another to determine the relative position and orientation of each sensor to translate information captured from each sensor to a joint coordinate system. This may permit data from multiple sensors to be aligned to a common coordinate system such that information from multiple sensors may be jointly interpreted.

The sensors may also include various sensors for perceiving the internal condition of the autonomous vehicle 100, such as a microphone to receive any noises or audible instructions from a passenger within the vehicle or a camera for viewing the passenger cabin.

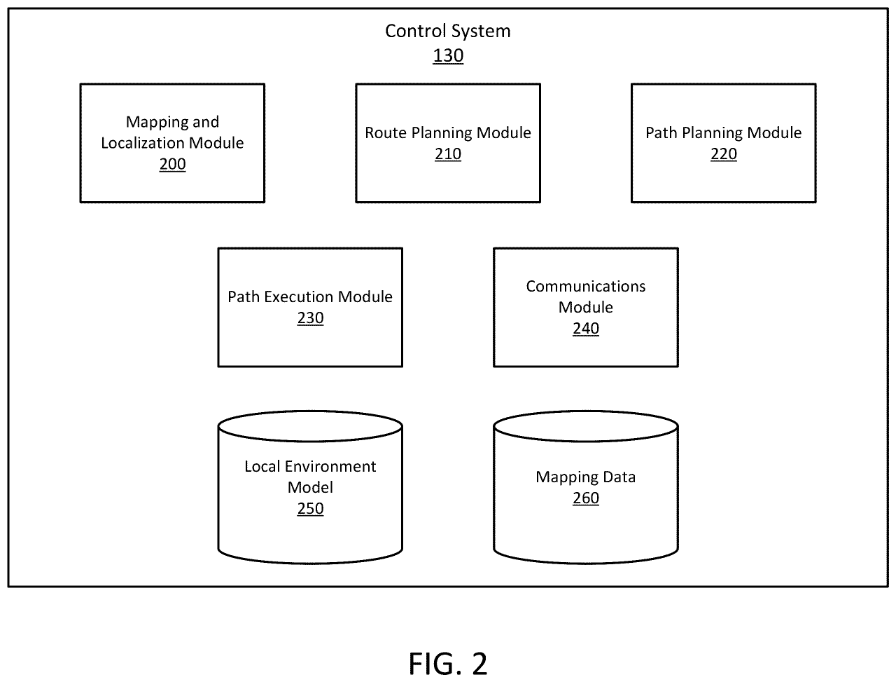

The control system 130 receives sensor data from the sensor system 120 and generates signals for the control of the components of the movement system 110 to navigate the autonomous vehicle 100 within its environment. The control system 130 thus may include components for perceiving the environment based on the sensor data, planning movement, and executing movement with control signals. The control system 130 is further discussed in FIG. 2.

Although generally the autonomous vehicle 100 refers to a vehicle typically operated on a road, such as a car, light truck, heavy truck, principles of this disclosure may also apply to other types of autonomously- or partially-autonomously-operated vehicles. Such additional types of autonomous vehicles 100 may include aerial vehicles such as drones, helicopters, or planes, as well as aquatic vehicles including surface and sub-surface vehicles. As such, the principles discussed herein may generally apply to systems that sense environmental information, analyze and perceive aspects of the environment, and/or provide for automated control of the autonomous vehicle 100.

Not shown in FIG. 1 are various additional components that may be included in various embodiments and are omitted for the purpose of simplifying the discussion herein. For example, the autonomous vehicle 100 may include lights (e.g., headlights, brake lights, etc.), signaling mechanisms, access control (e.g., door locks), battery, fuel storage, and other suitable components.

FIG. 2 shows components of the control system 130, according to one embodiment.

The control system 130 includes various components for processing sensor data to perceive the environment of the autonomous vehicle 100 and provide control signals to the movement system 110. The control system 130 may include various computing modules and data storage elements. To perceive and understand the environment, a mapping and localization module 200 may generate and maintain a local environment model 250 that describes conditions of the current environment around the autonomous vehicle 100, such as various objects perceived in the environment based on received sensor data and in conjunction with a set of mapping data 260. Additional modules, such as a route planning module 210, a path planning module 220, and a path execution module 230, determine and execute long- and short-term movement planning. Finally, a communications module 240 may communicate with external systems, both to coordinate movement of the autonomous vehicle 100 and to update software and data components.

In further detail, the mapping and localization module 200 determines and maintains the local environmental model 250 and may implement an environment perception stack for identifying objects and characteristics of the environment. The local environment model 250 may thus describe individual objects in the environment, e.g., objects, people, trees, signs, etc., in a virtual model of the environment consistent with the sensor data. The position of the objects relative to one another along with a current velocity (e.g., with respect to other objects, non-moving/background objects, or the autonomous vehicle 100) may be characterized in the local environmental model 250. The mapping and localization module 200 may also predict future movement of the perceived objects at various timeframes based, e.g., on the current velocity, as well as other sensed data that may predict future change in heading or intention by the object. As such, while the current velocity of a detected object may be expected to continue for at least a short timeframe (e.g., 50 ms), over longer timeframes the objects may be predicted to continue at that heading and speed, slow down, speed up, change direction, and so forth. For example, when a “stop” sign is in the environment ahead of a vehicle, the vehicle may be expected to change its speed to reduce speed and likely stop in the vicinity of the stop sign. The expected movement of objects at different timeframes may thus be predicted with different levels of confidence and may be probabilistically represented according to different types of actions that may be inferred for moving objects. For example, a pedestrian on a street corner may continue to stand at the corner or may, at some future time, enter the street to cross.

To build and update the local environment model 250, the mapping and localization module 200 may process the received data from the various sensors and apply object recognition, motion prediction, and localization algorithms. That is, the mapping and localization module 200 determines objects in the environment, predicts how those objects may move, and determines the location of the autonomous vehicle 100 in relation to the environment. The state of the local environment may thus be stored as the local environment model 250.

To describe the local environment, the sensed information may be processed by various algorithms for perception and object detection. The various sensor data may be individually processed as well as processed in combination with other sensor data of the same or different types. For example, in some embodiments, multiple image sensors may overlap in the portions of the environment viewable by the respective sensors. The captured images may be stitched together to form a larger image for the combined regions, and the respective difference in apparent size and position of an object from the cameras may also be used to infer distance to the object from the images. In some embodiments, imaging sensors may be disposed around the autonomous vehicle, such that the captured images may be merged to form a panoramic view of the environment. In addition, the captured image data and other sensor data (e.g., RADAR and LIDAR point cloud data) may be processed by one or more neural networks for object segmentation and identification. These networks may perform processing on sensor data individually (e.g., initial object identification based on image or LIDAR data alone) and may include networks (or network layers) for joint processing of multiple sensor types together.

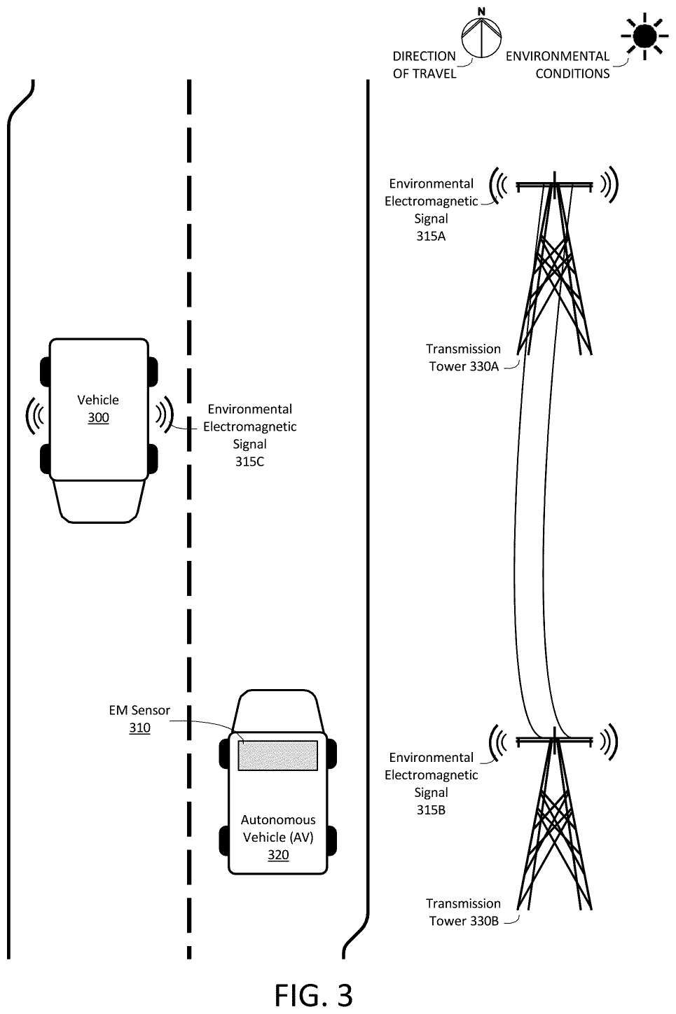

The mapping and localization module 200 may also process sensor data, e.g., EM sensor data, to characterize the environment with respect to the received EM sensor data. The received EM sensor data may be used to describe various characteristics of the environment and create an EM map describing received EM sensor data, objects and/or other conditions of the environment. The EM map may form a portion of the local environment model 250 and may be used to detect objects and orient the AV in the environment, and features of the EM map may also be used to modify control of the AV. Further details of environments in which the EM map may be generated by the mapping and localization module 200 are further discussed in FIGS. 3-6.

The current local environment model 250 may also be sequentially generated and updated at a frequency based on the sensor information since the last update. As such, each local environment model 250 may represent a “frame” of the perceived environment. In addition, the current local environment model 250 may also account for prior captured sensor data (e.g., of a prior frame) and prior frames of the local environmental model in constructing a current local environment model 250. This may permit, for example, object and motion tracking over time to improve object classification as well as movement prediction and to account for objects which may be temporarily obscured by other objects. In some embodiments, the construction and maintenance of the local environment model 250 may be performed based on the captured sensor data by the sensor system 120.

The environment mapping may also be performed in conjunction with information from the mapping data 260. The mapping data 260 stores longer-term data about various regions that may be used for localization and route planning. For example, the mapping data 260 may include roads, landmarks, coordinates, road signs and other road control information, and various other information associated with a mapping of the world that is generally expected to be relatively stable over time. Detected objects and other sensor data may be used to determine the position of the autonomous vehicle with respect to the known information in the mapping data 260. For example, the GPS location information may be used to determine the likely position of the vehicle with respect to the mapping data 260. However, as GPS location information may be distorted or imprecise, particularly when navigating environments with many buildings or other interference, additional information may be used to synchronize the perceived environment with the mapping data 260. For example, locally-perceived objects and other signatures of the environment may be matched with known landmarks and characteristics in the mapping data 260. After determining the location of the autonomous vehicle with respect to the mapping data 260, the local environment model 250 may also be supplemented with information from the mapping data 260, for example, to provide information about areas of the environment beyond the perception range of the sensors of the sensor system 120. This information may be useful, for example, for longer-term motion planning or movement prediction of other objects. For example, the sensors may perceive objects that obscure road signs from the sensor system 120 that may be known or expected in the environment based on the mapping data 260.

The local environment model 250 may also be used to update the mapping data 260 when the locally-sensed data differs from the mapping data 260. For example, the sensor data may not perceive a road sign at a location designated in the mapping data 260 despite a view of that location, or a road may be closed or under construction or otherwise in a different condition than designated in the mapping data 260. The mapping and localization module 200 may communicate differences between the mapping data 260 and the locally-perceived environment to an external system that maintains the mapping data 260.

The route planning module 210 determines longer-range planning and routing for the autonomous vehicle 100 and may determine, for example, an expected navigation route from an origin to a destination. Conceptually, the route planning module 210 may determine the high-level navigation objective and route, in contrast to the path planning module 220, which may determine short-term navigation with respect to the local environment model 250. While discussed here as separate components, in practice, these components may be jointly implemented, and the longer-term route planning may be affected by information discovered from the local path execution or environmental perception. For example, a planned route may indicate travel along a road that the local environment model 250 indicates is not available or for which there is no executable path to reach, such that another destination or route must be determined.

The route planning module 210 may determine the current location of the autonomous vehicle 100 and a destination and the overall route (e.g., individual roads and turns) to arrive at the destination from the current location. The route may be determined by available ways to reach the destination from the origin and evaluated with respect to traversal costs such as expected travel speeds, fuel usage, time, ride smoothness/passenger comfort, traffic, and so forth. The available ways of reaching the destination may be explored by various traversal algorithms based on the costs of traversing different routes and cost preferences for combining different types of costs.

The route planning module 210 may also receive instructions from an external system specifying a route or a destination. For example, the external system may coordinate destinations for many autonomous vehicles, such as destinations for passenger or cargo pickup/delivery, for vehicle maintenance or refueling, and so forth. The destination and/or a route for reaching the destination may thus be determined by the route planning module 210 or provided by the external system.

The path planning module 220 determines a path for navigating the local environment based on the local environment model 250 and the desired route specified by the route planning module 210. As such, the route from the route planning module 210 may provide a route indicating that the autonomous vehicle should turn right at the next street in approximately two miles. The path planning module 220 evaluates objects in the local environment (e.g., other cars, pedestrians, etc.) and determines the desired path for the autonomous vehicle 100 to navigate to and execute the turn. This may include, for example, changing lanes to a turn lane based on available space in the turn lane, stopping at the intersection, executing the turn, and so forth.

The path planning module 220 may look ahead an amount of time in predicting the movement of objects during its planning and update the planned path for each frame that the local environment model 250 is updated. The path planning module 220 may thus provide desired speed, turning, and other information to the path execution module 230 for execution.

The path execution module 230 executes the path with the various movement control signals for the movement system 110 to execute. Such signals may control application of the throttle, brake, and steering to execute the planned path. The path execution module 230 may include feedback mechanisms for verifying expected execution of the signals by the movement system 110, for example, to confirm a wheel-speed sensor is affected by application of the brake or throttle or that the specified speed along the path is achieved by the applied throttle signal. As such, the path execution module 230 translates the higher-level path instructions to specific signals that control the physical components of the movement system 110.

The communications module 240 coordinates messaging with other systems and devices. As one example, the communications module 240 may be used for updating the mapping data 260 based on data kept by an external data source. As another example, the communications module 240 may provide diagnostic, operations, and safety information for monitoring of the autonomous vehicle 100. As such, the communication module 240 may use respective communication components (e.g., transceivers) for various communication modalities such as cellular or wireless communications.

The control system 130 may include additional modules or components for control and management of the autonomous vehicle 100 that are not explicitly shown here. For example, the control system 130 may include voice recognition and control components for interpreting commands by a passenger, a module for coordinating communication of the passenger with a remote technician via the communications module 240, and modules for operating various other features or components of the autonomous vehicle.

### EM Sensor Information

FIGS. 3-5 show example environments in which an AV may sense EM signals and uses the received signals to characterize the environment, according to various embodiments. As shown in FIG. 3, an AV 320 may be equipped with an EM sensor 310 that receives EM signals from the environment. As discussed above, the EM sensor may include various types of antennas and may capture EM signals as electrical fields or magnetic fields in one or more directions. In the environment of FIG. 3, various aspects of the environment may either emit EM signals that may be received by the AV 320 or may affect travel of emitted signals. For example, in the example of FIG. 3, the environment around the AV 320 includes environmental electromagnetic (EM) signals 315 emitted by various objects: a transmission tower 330A may emit an environmental EM signal 315A, another transmission tower 330B may emit an environmental EM signal 315B, and a vehicle 300 may emit an environmental EM signal 315C. Each of the signals emitted by these types of objects may vary over time and may vary according to the distance of the EM sensor 310 from the objects emitting EM signals.

In addition, various environmental characteristics of the environment such as weather may also influence the receipt of the signals by the AV 320. For example, the environmental conditions shown in FIG. 3 shows a clear, sunny day which may provide little interference with the EM signals 315 as they travel from the respective sources (e.g., vehicle 300 and transmission towers 330A-B) to the EM sensor 310.

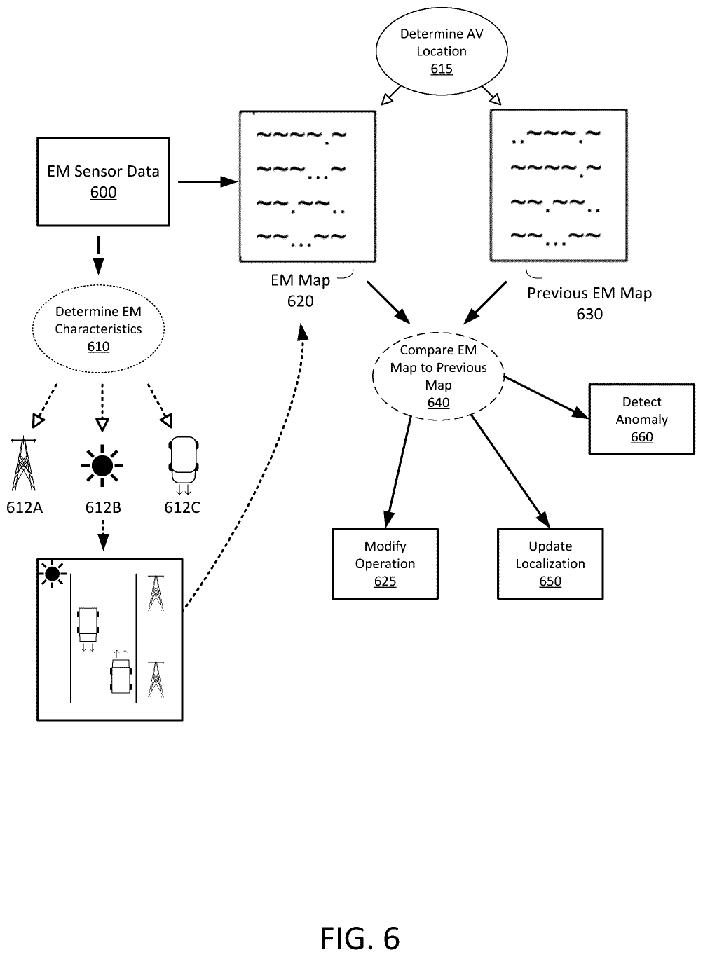

As discussed further below, analysis of the received EM signals may enable the EM sensor 310 to process the received EM sensor data to describe the environment with respect to received EM signals and generate an EM map of the environment based on the signals and/or any EM characteristics determined from the signals. The EM map may enable the AV to describe features of the environment that may be detected by the EM sensor 310 but may otherwise be difficult to detect based on other sensor data. For example, objects emitting EM signals in the environment may be out of view of visual sensors and various active sensors, while EM sensor data may receive a signal from these objects. Similarly, characteristics or properties of certain objects may be detectable based on received EM signals and used to describe the current state of those objects. Processes for such detection are discussed further with respect to FIG. 6.

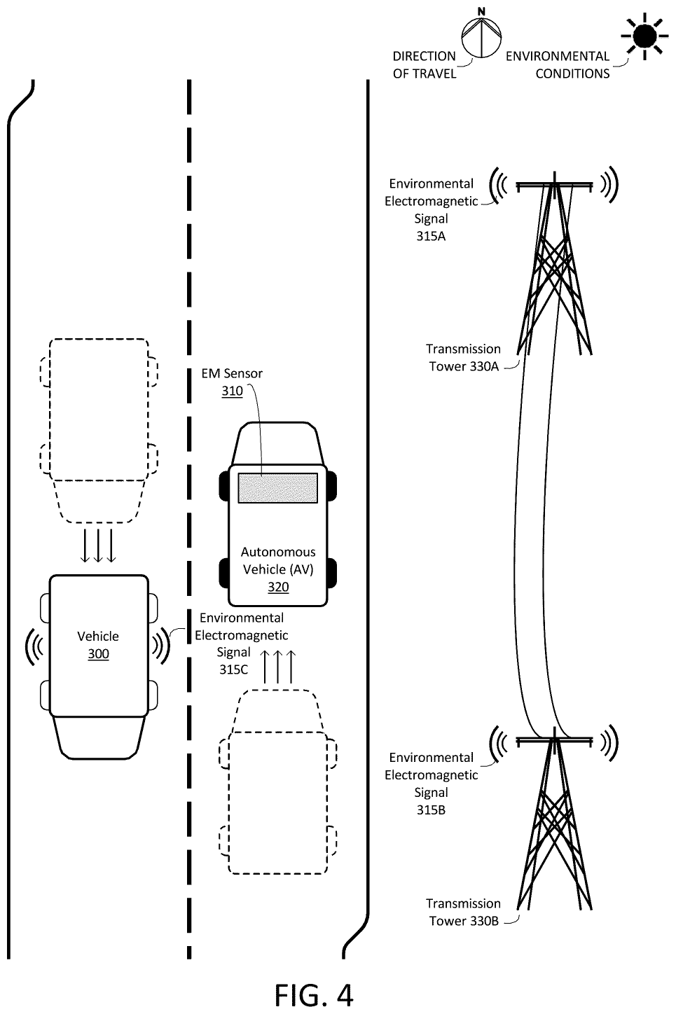

FIG. 4 shows the example environment of FIG. 3 as the environment changes over time. The change in EM signal over time may also be used to describe characteristics or movement of the objects emitting the respective environmental EM signals 315. In this example, the AV 320 has moved in the environment, as has the vehicle 300, while the transmission towers 330A-B remain stationary. From the perspective of the EM sensor 310, this may affect the signal received by the EM sensor 310, even when the emitted EM signal may remain constant. For example, as the AV 320 travels away from the transmission tower 330B, the received environmental EM signal 315B emitted by the transmission tower 330B (even if it is emitted at a constant frequency) may be perceived at a lower amplitude (as the absolute distance increases) and at a lower frequency (as a function of the movement away from the source of the transmission). Similarly, the environmental EM signal 315C as perceived by the EM sensor 310 may appear to become stronger (e.g., higher amplitude) and at a higher frequency as the distance between the AV 320 and the vehicle 300 decreases. These various characteristics of the changing signal received by the EM sensor 310 over time may be thus be used to determine characteristics of the environment, such as the type of object emitting an EM signal and the relative and/or absolute movement of that object in the environment.

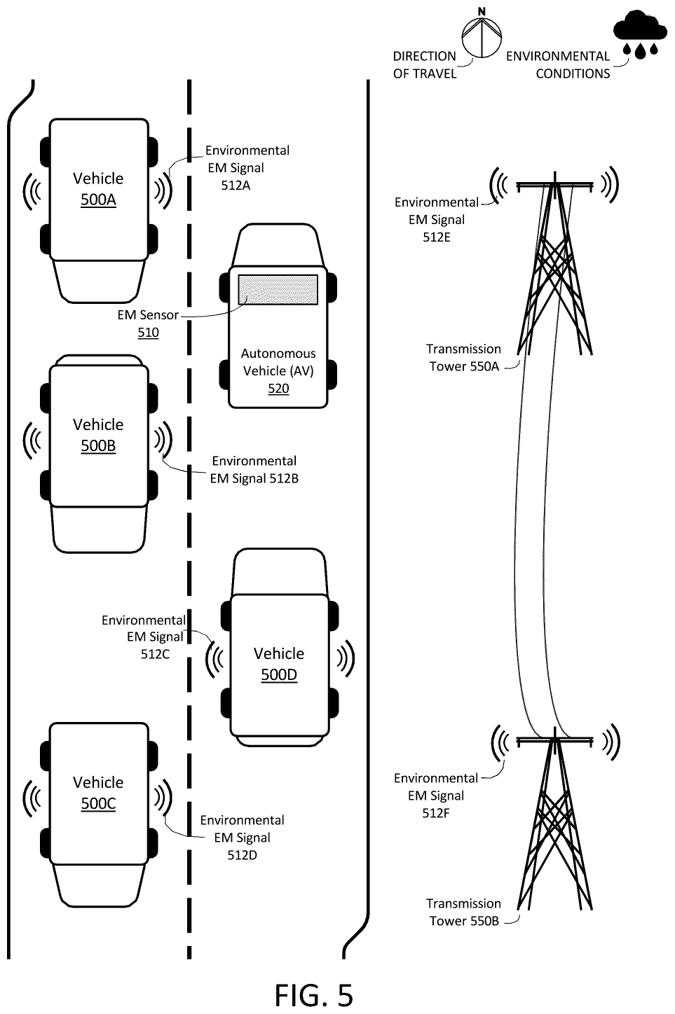

FIG. 5 shows an example of the same environment of FIGS. 3 and 4 at a different time, such as the following day or week, for another AV 520. In the example of FIG. 5, the AV 520 has an EM sensor 510 that receives environmental EM signals 512A-F as emitted from the various objects, such as transmission towers 550A-B and vehicles 500A-D. In addition, the weather conditions and other environmental characteristics may also be different relative to the same environment as shown in FIGS. 3 and 4. In this example, rather than sunny weather, the weather-related environmental conditions may include clouds and rain, which may interfere with the reception of environmental EM signals 512 by the EM sensor 510 and add additional noise. As such, while the AV 520 is in the same environment and similar position within the environment as the AV 320 of FIGS. 3-4, the received environmental EM signals 512A-F by the EM sensor 510 may provide different information signifying different characteristics in the environment.

### EM Maps

FIG. 6 provides a flow for processing EM sensor data to generate an EM map, according to one embodiment. The EM map may then be used for control of the AV, to identify anomalies in the environment, modify a previous map, or re-localize the AV in various embodiments. As discussed above, the EM sensor data 600 present in the environment and captured by an EM sensor may vary in different conditions of the same environment. The received signals may be used to generate an EM map 620 of the environment that describes the received EM signals at various locations and how the received EM signals may vary across positions in the map and/or across time (e.g., different EM signals may be received at the same position as a function of time). The EM sensor data may be described for the map by determining 615 a location of the AV and associating received EM sensor data with the localized position of the AV in the map. These and other aspects are further discussed below.

In some embodiments, the EM sensor data 600 is processed to determine EM characteristics 610 of the environment. The EM characteristics may describe the sources emitting the EM signals and be used to identify types of objects and properties thereof, such as vehicles or stationary EM emitters, or may be used to describe characteristics of “known” structures or features in the environment, or may be used to describe environmental characteristics that may not have a specific location, such as a weather condition. As such, detected EM characteristics 612 illustrated in FIG. 6 include a transmission tower 612A, sunny weather 612B, and a vehicle 612C.

As discussed above, the emission characteristics, movement the AV, as well as the movement of objects in the environment may each affect the characteristics of the EM signals received by the AV from various EM characteristics in the environment. As such, the EM characteristics 610 may be detected in various ways in various embodiments.

The EM signals emitted by various types of moving objects may be easier to detect and characterize as an EM signature than as other types of sensor data. For example, the EM signals of heavy lightning or a thunderstorm may be readily characterized in an EM signature, while other objects may emit EM signals but otherwise be out of view or perception of other sensors, for example, emergency or heavy vehicles that emit higher levels of EM signals may be distinguishable by processing the received EM sensor data.

In one embodiment, signals associated with various characteristics may be determined based on various signal processing techniques, such as time- or location-based spectral analysis. In one embodiment, the EM signals from various types of objects and in various types of conditions may be captured, labeled, and used as references for signal processing of the received EM sensor data 600. In one example, a reference signal for different types of EM characteristics 610 may be stored and used to pattern-match received signals to the stored reference signals. In this example, the EM characteristics may be determined based on a numerical optimization of the received sensor data relative to matching a number of the reference signals.

As another example, a computer model trained to determine a set of EM characteristics in the environment as a function of the captured EM sensor data 600. The training may be conducted using Machine Learning or Deep Learning. The computer model may characterize the sensor data 600 as various magnitudes, directions, frequencies, etc., over time and analyze the sensor data 600 with respect to various EM signal sources and other EM characteristics (e.g., weather conditions). Training data for the computer model may be generated based on captured and labeled EM data for different types of EM characteristics 610, such that the model may learn the associated representation in the captured EM sensor data 600 between captured signals and the respective EM characteristics. In various embodiments, the model may be a multi-class classification, such that various types of EM characteristics are considered individual classes that may be predicted by the model. By associating captured EM sensor data with training data labels, the model is trained to learn parameters that classify incoming EM sensor data 600 and produce detected EM characteristics 612 from the received EM sensor data 600. The training may use raw EM sensor data or processed EM sensor data. The processed EM sensor data may comprise time filtered data, frequency domain data, time-frequency domain data, EM signal magnitude data, EM signal phase data, EM signal magnitude ratio data between two EM sensors, and/or EM signal phase difference data between two EM sensors.

In addition, the relative position and movement of objects may also be determined based on the relative increase or decrease in emitted frequency relative to the EM sensor and as a function of the movement of the AV. As discussed above, the AV moving away from an EM source may cause the EM signal to become lower in frequency; by determining the AV's movement (e.g., based on a speedometer), the signal may be adjusted to determine the relative as well as the absolute movement of a detected object. Likewise, the relative location of an object may be determined as the AV moves by determining whether the detected EM signal from a detected object is increasing or decreasing in magnitude or another signal characteristics. In addition, other characteristics of an object in the environment may also be detected, such as the EM emissions from a factory or airfield, which may indicate the relative level of activity of those locations and may be predictive of current or future traffic related to the area.

As additional examples of types of EM characteristics that may be detected, the following may be detected by analyzing the EM sensor data 600 in various embodiments:
Other vehicles, such as other AVs, along with the location and relative movement
Emergency vehicles, such as police, fire, or ambulance vehicles, along with location, relative movement, and whether additional EM signals are activated (e.g., a siren)
A traffic light and its active signals
An airport, its location, and its activity level
A factory, its location, and its occupancy/activity level
Lightning and other weather-related EM sources and associated locations
Weather conditions such as snow, rain, storms, and other effects.
Wires or other electrically or magnetically charged objects (rocks, construction material, etc.) on or below the surface of the road

The EM sensor data 600 and/or the various EM characteristics 612 in the environment may be localized to an EM map 620 based on a determined AV location 615. The location of the AV may be determined 615 by various methods, which may include, for example, localization based on a GPS signal, or mapping objects/locations perceived by vehicle sensors (e.g., lidar or camera) to objects/locations within a mapped environment. The EM sensor data 600 and/or EM characteristics 612 may then be localized within the environment and associated with the respective locations of sensor data, objects, and conditions in the EM map 620. The EM map 620 in various embodiments may describe different types of information, such that the EM sensor data 600, processed or filtered EM sensor data, and/or various detected EM characteristics 612. In some embodiments, the EM sensor data 600 may be processed to characterize the received sensor data, e.g., based on its strength, frequency, etc., for association of the received EM sensor data 600 with the EM map 620 (e.g., rather than or in addition to the raw EM sensor data). As the AV (and hence the EM sensor) navigates the environment, the received EM signals are associated with the location of the AV at which the signals were received, enabling navigable areas to be mapped with respect to the received EM signals at different locations and further navigation and control based on that mapping.

As such, the EM map 620 includes information describing the received EM sensor data at different positions in the map and may be described in various ways. The EM map 620 may include a description of the sensor data itself and may also include the position of detected EM characteristics 612. The EM characteristics 612 may also then model the location of objects that may affect the received EM signals at different location in the EM map. Therefore, the EM map 620 may describe the received EM signals at different areas and in some embodiments may include respective “signatures” of EM sources/emitters in the environment (e.g., as determined by interpretation of the received EM signal data). Although a two-dimensional map is shown in FIG. 6, the EM map may be any suitable representation of the received EM signals/detected EM characteristics with respect to physical locations in the environment and the position of the sources of the received EM signals. As such, in one embodiment, the EM map is a set of detected EM characteristics (e.g., EM characteristics 612) associated with a particular location in the environment. In another embodiment, the EM map may be a 1D path or 2D array of locations and associated placements of EM characteristics with the locations.

The EM map 620 may then be used, alone or with comparison to a previous EM map 630, for various purposes to improve AV control, navigation, perception, or other functionality as further discussed below. As one example, the EM sensor data 600 or EM map 620 may indicate conditions for modifying operation 625 of the AV without comparison to a previous EM map 630 (e.g., when a high magnitude of EM signals are received that may be indicative of an emergency condition). As another example, the EM map 620 may be used, e.g., alone or combined with other sensor data, to improve the detected features of the environment in generating a local environment model 250. Objects and characteristics thereof may be combined with objects detected by other sensors to add additional information for objects, more precisely locate objects or classify them, and so forth.

As another example, the EM map 620 may also be used to modify operation and/or control 625 of the AV within the environment based on the received EM sensor data, detected EM characteristics, and the respective location of signals or characteristics within the EM map 620. As one example, detected EM characteristics such as detected objects and properties thereof may be used to modify AV behavior, for example, detected vehicles, autonomous vehicles, emergency vehicles, traffic lights, and activity (e.g., of a factory or airport) may be used to affect planning and navigation of the AV within the environment. As another example, detected weather conditions may also modify operation 625 of the AV, for example, by reducing operational speeds or increasing ride smoothness when significant weather is detected. As another example, the operation of the AV may be affected when a level of received EM signals is higher than a predetermined threshold which may suggest an abnormal condition in the environment, such that the AV may be placed in a more cautious operational state (e.g., accelerating more slowly, planning more cautiously, and so forth).

As another example, the EM map 620, EM sensor data 600 and/or detected EM characteristics may also be transmitted to an external system that coordinates operation of other AVs. For example, significant detected EM activity generally (e.g., high magnitudes) or as detected from a particular source (e.g., high EM signatures detected from a factory, airfield, or similar location) may be sent to indicate the unusual activity and allow coordination with respect to the activity. This activity may suggest that other AVs should generally avoid the current location of the AV and the external coordination system may de-prioritize routes around the location.

As additional examples, the EM map 620 may also be compared 640 with a previous map 630 of the location to determine whether the currently detected EM map 620 is similar to the previous map 630 of the location. The previous map 630 may be obtained based on the determined location 615 for the AV and the corresponding previous map 630 may be retrieved from storage at the AV (e.g., via mapping data 260) or through communication with an external system (e.g., via communications module 240). Because many aspects of the EM sensor data 600 and determined EM characteristics of the environment at the same location may change over time (e.g., compare FIGS. 3 & 5), the previous map 630 may describe the EM information of the location in various ways. For example, the previous map 630 may describe received EM sensor data 600 at a given location as it may vary over time and in different conditions. Detected EM emitters may also be described as EM signatures of stationary objects in the environment that are expected to emit EM signals with a consistent signature. Additional received EM sensor data or sources of EM signals that may be represented in the previous map 630 may vary over time and may be described probabilistically as part of a statistical map. Such varying EM sensor data (and detected characteristics), data may also be described as a function of time, as different types of EM signals may be more likely at that location during different times of day, week, and so forth. When the EM map 620 for a location is generated, the EM map 620 may be used to update the previous map 630, for example, to refine the probabilistic EM sensor data or detected characteristics at that location based on the observed sensor signals by the AV 100. The previous map 630 may be updated at the AV 100 (e.g., in mapping data 260) or may be updated at an external system.

By comparing the EM map 620 to the previous map 630, the AV (e.g., the mapping and localization module 200) may determine whether the current EM map 620 is consistent with the previous map 630 of the location. When the EM map 620 differs from the previous map 630, it may reflect that the detected location is incorrect (e.g., the AV is actually in a different location than the determined location) or that there is an anomaly in the environment with respect to the previously-detected EM signals. In one embodiment, the EM map 620 is considered to differ when the EM map 620 includes EM sensor data 600 or an EM signature that is not present in the previous map 630 or, for probabilistic EM sources, that the EM signal or detected EM signature in the EM map is below a threshold probability given the location and/or time.

In one embodiment, when a sufficient difference is determined, the location of the AV may be updated 650 to account for the detected EM sensor data. In various embodiments, sensor data used for localization may occasionally suffer interference, lack precision, or otherwise incorrectly provide location information. For example, GPS signals for localization may be imprecise or unreliable in certain environments (particularly crowded urban environments) and provide incorrect location information, such that the detected location may be incorrect, in which case the previous map 630 may be retrieved for the wrong location (e.g., the location is detected at a first location and used to retrieve a corresponding map, while the detected EM sensor data 600 is actually obtained by the AV at a second location). As such, when there is a difference or detected anomaly in the EM map 620, in one embodiment the location of the AV is updated 650 and may be detected by another process. For example, location information may initially be obtained via one process (e.g., GPS sensor data), and updated 650 based on (or to account for) different sensor data (e.g., LIDAR detection and known objects in a mapped area).

In additional examples, in various embodiments, the difference between the EM map 620 and the previous map 630 may be characterized as a detected anomaly 660 for that location. The detected anomaly 660 may describe the EM sensor data 600 and other characteristics of the EM map 620 that is inconsistent with the previous map 630. In the example shown in FIG. 6, the EM map 620 includes different signals in different regions relative to the previous EM map 630, which may be identified as an anomaly with respect to the expected EM sensor data reflected in the previous map 630. The anomaly may be used, for example, to modify operation 625 of the AV, or may be used to update stored mapping data (e.g., to update the previous map 630 for subsequent use). In one embodiment, the anomaly may be identified as a region or point of interest to be confirmed by additional AVs and respective EM sensors before the previous map 630 is modified to include the detected anomaly as a persistent EM signal that may be properly identified with that location in the map.

As a result, the collected EM sensor data may be used for mapping locations and may also be processed and used to characterize the environment with respect to the EM sources and characteristics of the environment. This additional source of mapping information may then be used for further control and perception of environment, along with detection of information different than may otherwise be detected by sensors (e.g., vision or active scanning sensors) that are limited by line of sight.

### EXAMPLE EMBODIMENTS

Various embodiments of claimable subject matter includes the following examples.

Example 1 provides a method including: receiving electromagnetic (EM) sensor data for a EM sensor on a vehicle; determining a location of the vehicle based on sensor data of the vehicle; and generating an EM map of the location describing the received EM sensor data for the location.

Example 2 provides for the method of example 1, further including determining one or more environmental characteristics based on the EM sensor data; and wherein the EM map includes the one or more environmental characteristics.

Example 3 provides for the method of example 2, wherein the determined one or more environmental characteristics are based on spectral analysis of the sensor data.

Example 4 provides for the method of example 2, wherein the one or more environmental characteristics are determined with a machine-learned model.

Example 5 provides for the method of any of examples 1-4, further comprising updating the location of the vehicle based on a comparison of the EM map with a previous EM map of the location.

Example 6 provides for the method of any of examples 1-5, further comprising determining an anomaly in the EM map based on a comparison of the EM map with a previous EM map of the location.

Example 7 provides for the method of any of examples 1-6, further comprising adjusting operation of the vehicle based on the received EM sensor data.

Example 8 provides for the method of any of examples 1-7, further comprising generating an EM statistical map for the location based on a plurality of EM maps.

Example 9 provides a system including: receiving electromagnetic (EM) sensor data for a EM sensor on a vehicle; determining a location of the vehicle based on sensor data of the vehicle; and generating an EM map of the location describing the received EM sensor data for the location.

Example 10 provides for the system of example 9, further including determining one or more environmental characteristics based on the EM sensor data; and wherein the EM map includes the one or more environmental characteristics.

Example 11 provides for the system of example 10, wherein the determined one or more environmental characteristics are based on spectral analysis of the sensor data.

Example 12 provides for the system of example 10, wherein the one or more environmental characteristics are determined with a machine-learned mode.

Example 13 provides for the system of any of examples 9-12, wherein the instructions are further executable by the processor for updating the location of the vehicle based on a comparison of the EM map with a previous EM map of the location.

Example 14 provides for the system of any of examples 9-13, wherein the instructions are further executable by the processor for determining an anomaly in the EM map based on a comparison of the EM map with a previous EM map of the location.

Example 15 provides for the system of any of examples 9-14, wherein the instructions are further executable by the processor for adjusting operation of the vehicle based on the received EM sensor data.

Example 16 provides for the system of any of examples 9-15, wherein the instructions are further executable by the processor for comprising generating an EM statistical map for the location based on a plurality of EM maps.

Example 17 provides for the non-transitory computer-readable medium containing instructions executable by one or more processors including: receiving electromagnetic (EM) sensor data for a EM sensor on a vehicle; determining a location of the vehicle based on sensor data of the vehicle; and generating an EM map of the location describing the received EM sensor data for the location.

Example 18 provides for the computer-readable medium of example 17, further including determining one or more environmental characteristics based on the EM sensor data; and wherein the EM map includes the one or more environmental characteristics.

Example 19 provides for the computer-readable medium of example 18. wherein the determined one or more environmental characteristics are based on spectral analysis of the sensor data.

Example 20 provides for the computer-readable medium of example 18, wherein the one or more environmental characteristics are determined with a machine-learned model.

Example 21 provides for the computer-readable medium of any of examples 17-20, further comprising updating the location of the vehicle based on a comparison of the EM map with a previous EM map of the location.

Example 22 provides for the computer-readable medium of any of examples 17-21, further comprising determining an anomaly in the EM map based on a comparison of the EM map with a previous EM map of the location.

Example 23 provides for the computer-readable medium of any of examples 17-22, further comprising adjusting operation of the vehicle based on the received EM sensor data.

Example 24 provides for the computer-readable medium of any of examples 17-23, further comprising generating an EM statistical map for the location based on a plurality of EM maps.

### OTHER IMPLEMENTATION NOTES, VARIATIONS, AND APPLICATIONS

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

Specifications, dimensions, and relationships outlined herein (e.g., the number of processors, logic operations, etc.) have been offered for purposes of example and teaching only. Such information may be varied considerably without departing from the spirit of the present disclosure or the scope of the appended claims. In the foregoing description, various non-limiting example embodiments have been described with reference to particular arrangements of components. Various modifications and changes may be made to such embodiments without departing from the scope of the appended claims. This description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the figures may be combined in various possible configurations, all of which are clearly within the broad scope of this disclosure.

Note that in this specification, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like, are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving electromagnetic (EM) sensor data for an EM sensor on a vehicle;
determining a location of the vehicle based on sensor data of the vehicle; and
generating an EM map of the location describing the received EM sensor data for the location.

2. The method of claim 1, further comprising:
determining one or more environmental characteristics based on the EM sensor data; and
wherein the EM map includes the one or more environmental characteristics.

3. The method of claim 2, wherein the determined one or more environmental characteristics are based on spectral analysis of the sensor data.

4. The method of claim 2, wherein the one or more environmental characteristics are determined with a machine-learned model.

5. The method of claim 1, further comprising updating the location of the vehicle based on a comparison of the EM map with a previous EM map of the location.

6. The method of claim 1, further comprising determining an anomaly in the EM map based on a comparison of the EM map with a previous EM map of the location.

7. The method of claim 1, further comprising adjusting operation of the vehicle based on the received EM sensor data.

8. The method of claim 1, further comprising generating an EM statistical map for the location based on a plurality of EM maps.

9. A system comprising:
a processor; and
a non-transitory computer-readable storage medium containing instructions for execution by the processor for:
receiving electromagnetic (EM) sensor data for an EM sensor on a vehicle;
determining a location of the vehicle based on sensor data of the autonomous vehicle; and
generating an EM map of the location describing the received EM sensor data for the location.

10. The system of claim 9, wherein the instructions are further executable by the processor for:
determining one or more environmental characteristics based on the EM sensor data; and
wherein the EM map includes the one or more environmental characteristics.

11. The system of claim 10, wherein the determined one or more environmental characteristics are based on spectral analysis of the sensor data.

12. The system of claim 10, wherein the one or more environmental characteristics are determined with a machine-learned model.

13. The system of claim 9, wherein the instructions are further executable by the processor for updating the location of the vehicle based on a comparison of the EM map with a previous EM map of the location.

14. The system of claim 9, wherein the instructions are further executable by the processor for determining an anomaly in the EM map based on a comparison of the EM map with a previous EM map of the location.

15. The system of claim 9, wherein the instructions are further executable by the processor for adjusting operation of the vehicle based on the received EM sensor data.

16. The system of claim 9, wherein the instructions are further executable by the processor for comprising generating an EM statistical map for the location based on a plurality of EM maps.

17. A non-transitory computer-readable medium containing instructions executable by one or more processors for:
receiving electromagnetic (EM) sensor data for an EM sensor on a vehicle;
determining a location of the vehicle based on sensor data of the vehicle; and
generating an EM map of the location based on the one or more environmental characteristics.

18. The computer-readable medium of claim 17, further comprising:
determining one or more environmental characteristics based on the EM sensor data; and
wherein the EM map includes the one or more environmental characteristics.

19. The computer-readable medium of claim 18, wherein the determined one or more environmental characteristics are based on spectral analysis of the EM sensor data.

20. The computer-readable medium of claim 18, wherein the one or more environmental characteristics are determined with a machine-learned model.
